(19) United States
(12) Patent Application Publication
(10) Pub. No.: US 2026/0214251 A1
(43) Pub. Date: Jul. 23, 2026

(54) SYSTEMS AND METHODS FOR CONTENT ADAPTIVE MULTI-SCALE FEATURE LAYER FILTERING

(71) Applicant: OP Solutions LLC, Amherst, MA (US)

(72) Inventors: Hari Kalva, Boca Raton, FL (US); Borivoje Furht, Boca Raton, FL (US); Velibor Adzic, Canton, GA (US); Juan Merlos, Wellington, FL (US)

(73) Assignee: OP Solutions LLC, Amherst, MA (US)

(21) Appl. No.: 19/563,519

(22) Filed: Mar. 11, 2026

Related U.S. Application Data
(63) Continuation of application No. PCT/US24/46368, filed on Sep. 12, 2024.
(60) Provisional application No. 63/537,927, filed on Sep. 12, 2023.

(51) Int. Cl. H04N 19/33; G06N 3/0455; H04N 19/117; H04N 19/80

(52) U.S. Cl. CPC H04N 19/33; G06N 3/0455; H04N 19/117; H04N 19/80

(57) ABSTRACT

Systems and methods are provided for encoding and decoding video for machine consumption in which bandwidth is reduced by filtering feature layers at the encoder site that are determined to be redundant or of reduced relevance. A video encoder includes a neural network front end which receives image data and generates a plurality of feature layers. A layer context processor a redundant layer identifier cooperate to evaluates the context of objects in the image data and determine the relevance of the plurality of feature layers to a machine task at the decoder site. A layer filter then performs at least one of removing a redundant layer and scaling a layer identified as having low relevance to a machine task to generate a filtered layer set.

### STATEMENT OF RELATED CASES

The present application claims the benefit of priority to U.S. provisional application Ser. No. 63/537,927, filed on Sep. 12, 2023, and entitled “Content Adaptive Multi-Scale Feature Layer Filtering,” the disclosure of which is hereby incorporated by reference in its entirety.

### FIELD OF THE DISCLOSURE

The present application generally relates to the field of video encoding and decoding. In particular, the present invention is directed to systems and methods for reducing bandwidth in a video coding for machines system by selecting removing or modifying selected feature layers from an encoded bitstream

### BACKGROUND

As the number and scale of deployed video sensors/devices increases, an increasing amount of video is expected to be processed by machines. A system or solution employing thousands of cameras would produce huge amounts of video that cannot be monitored by humans in a cost-effective manner. Machines or computational systems that ingest and analyze video offer effective solutions to enable decision support systems and analytics engines. Machines designed to perform an analysis task are not sensitive to the quality and resolution of video as human operators are. Video Coding for Machines (VCM) addresses this opportunity to transform and represent video to minimize the computing, storage, and streaming of video data while ensuring that a machine task is performed with high operational efficiency.

Feature Coding based Video Coding for Machines (FCVCM) is based on the observation that video analysis based on convolutional neural networks (CNNs) are the most prominent solutions but require significant computational resources. FCVCM methods attempt to compress and transmit features of a video extracted from a CNN and on the receiver side, use the decompressed features to continue processing on a CNN that performs a machine task.

A typical CNN to perform object detection is shown in FIG. 1. A CNN trained using training data such as video, images, audio, LiDAR, thermal imagery, or even text is used to perform a task and provide information about data input to the network. An input image is processed first by the Feature Pyramid Network (FPN) 105 that produces feature maps at layers P2, P3, P4, and P5. The feature maps from layers P2, P3, P4, and P5 are further processed by a Region Proposal Network (RPN) 110 and a Box Head 115, which may include a fast region based convolutional network (Fast R-CNN) ConvFCHead 120 and a second Fast R-CNN for output layers 125 that determine the regions of interest (ROI) and detected labels for the ROIs. In such architectures, FPN 105, RPN 110, and the Box Head 115 represent computationally complex processes.

System complexity can be reduced, and the amount of data usage can also be reduced by splitting the computations performed in a CNN between a transmitter/camera and receiver side. In such architectures, a camera or video source end of a system would consist of a first portion, or front end, of the CNN such as the FPN 105. The output of the FPN, feature maps P2, P3, P4, and P5 are then compressed and transmitted to a receiver where the received and decompressed feature maps are input to the second portion of the network comprising components such as RPN 110 and Box Head 115 to complete the execution of the network and produce the network output. Such CNNs may be trained to perform tasks such as object detection, segmentation, action detection, and object tracking.

FIG. 2 shows a typical approach to processing such a split network. The NN part 1 205 represents the camera/video source where input video or image is process by a part 1 of the neural network to produce a plurality of feature maps, such as four feature maps P2, P3, P4, and P5. The number and structure of the feature maps depend on the neural network. For example, some networks may only have three feature maps rather than four. The size or dimension of each of the feature maps also depends on the neural network. The feature maps are prepared for compression by packing and quantizing the feature maps.

### NN Part 1

FIG. 3 further illustrates NN Part 1 305. In this stage, features are extracted from the Neural Network such as a Res-Net in FPN 105. These features can be composed of four layers P2 (310a), P3 (310b), P4 (310c), and P5 (310d), each with 256 channels. Each channel in each layer represents a convolution with a kernel and represents input image features. Typically, all channels of a given layer have the same dimensions. For example, as illustrated in FIG. 4, in layer P2, each channel has two dimensions P2cW and P2cH. These two dimensions, representing the width and height of the channel, depend on the input image and the neural network. Similarly, the channel dimensions in the other three layers of this example network can be represented with the corresponding channel width and height as P3cW×P3cH, P4cW×P4cH, and P5cW×P5cH.

In the case of a Feature Pyramid Network 105, each layer is smaller in size than the previous layer due to information loss from the neural networks pooling functionality that reduces the spatial size of the information to a more abstract representation. For example, each layer may be half the size of the previous layer, with p2 being the largest and p5 being the smallest layer.

Pixels of an image input to the network pass through the network. The extracted feature maps are the transformed input pixels in each channel of each of the feature maps. Features in each of the extracted channels are essentially floating-point values that represent input image features. Compressing or coding feature maps therefore requires compressing all values that represent input image features.

### Packing (Tiling) & 10-Bit Uniform Quantization

Referring back to FIG. 2, Packing 210 and quantization 215 are performed to convert the floating-point feature values of the neural network into an image representation, as well as augmenting data for the encoder, such as by using 10-bit quantization. It will be appreciated, however, that other quantization levels may be used.

For the packing and tiling phase 210, features are converted into image format by mapping channel data to pixels and assembling them by layers to form a full image. For example, consider a P2 layer with 256 channels and each channel with a width and height dimension of P2cW×P2cH. Channel data in such layers can be packed into tiles of size P2cW×P2cH that are laid as a rectangular grid, as illustrated in FIG. 4.

The feature map data from each of the 256 channels can be tiled into a grid with N×M tiles, each with size P2cW×P2cH. This results in an equivalent P2 layer feature map of width P2W=P2cW×N and height P2H=P2cH×M. The raw floating point feature map data of the P2 layer has a dimension of P2w×P2H. Such two-dimensional feature map data is normalized to a 10-bit representation resulting in a 10-bit image that corresponds to the P2 layer. Similarly, 10-bit layer images of layers P3, P4, and P5 are produced by tiling and normalization. Such normalization is also referred to as uniform 10-bit quantization as the floating-point feature map data is mapped to 1024 levels in a 10-bit representation of the data.

In the example of an R-CNN neural network, the size of each channel in the P3 layer is half that of the channel size in the P2 layer in each dimension. Similarly, the channel dimension in P4 is half that of P3, and the channel dimension in P5 is half that of P4. The amount of layer and channel data in P5, therefore, is significantly less than that of P2.

$$\begin{matrix}Width , P 2 W - P 2 cW \times N and \\ Height , P 2 H = P 2 cH \times M \\ M \times N = 256 ;\end{matrix} \qquad P2 layer$$

$$\begin{matrix}P 3 cW = P 2 cW / 2 ; P 3 cH = P 2 cH / 2 ; \\ Width , P 3 W = P 3 cW \times 2 N and \\ Height , P 3 H - P 3 cH \times M / 2\end{matrix} \qquad P3 layer$$

$$\begin{matrix}P 4 cW = P 3 cW / 2 = P 2 cW / 4 ; P 4 cH = P 3 cH / 2 = P 2 cH / 4 ; \\ Width , P 4 W = P 4 cW \times 4 N amd \\ Height , P 4 H = P 4 cH \times M / 4\end{matrix} \qquad P4 layer$$

$$\begin{matrix}P 5 cW = P 4 cW / 2 = P 2 cW / 8 ; P 5 cH = P 4 cH / 2 = P 2 cH / 8 ; \\ Width , P 5 W = P 5 cW \times 8 N and \\ Height , P 5 H = P 5 cH \times M \text{/8}\end{matrix} \qquad P5 layer$$

Channel data from all the four layers is packed into a single image and sent to the input of an encoder. Typically, the channels are tiled such that the channels of the p2 layer are arranged in a 16×16 grid in a predetermined channel order. The channels of the subsequent layers are tiled to fit the width of the P2 channel arrangement. An example of tiled channel data from P2, P3, P4 and P5 layers is shown in FIG. 5.

### Compression

With continued reference to FIG. 2, the tiled and quantized images are compressed using image and video compression 220 such as the versatile video coding (VVC) or any other image or video compression. The compressed data is transmitted to the receiver over communication networks.

### Decompression

The compressed channel image data is received and decompressed using an appropriate decompression system 225 to produce a decoded tiled image. If lossy compression is used, the decoded image may have distortion caused by the lossy compression.

### Dequantization & Unpacking

The received image is dequantized (de-normalized) 230 and converted to floating point feature map data which is then unpacked 235 into the corresponding channels of the original network features that can be fed into the second half of the neural network. In these operations, a reversal of the process in steps Packing (Tiling) 210 and Quantization 215 is completed.

### NN Part 2 Processing

Once the raw layer information is reconstructed from the decompressed data, it can be directly fed into the second part of the neural network (e.g., RPN and Box Head in the R-CNN example) NN Part 2 240 that will output the machine task output (e.g., object detection or segmentation information).

### Machine Task Performance

The machine task performance (e.g., accuracy of object detection or segmentation information) would be impacted by the methods used to compress the feature map data. A lossless compression would faithfully reconstruct feature maps and will not impact machine task performance at the receiver. Any lossy compression (e.g., using video or image compression tools) is likely to impact the machine task performance. Higher degradation in machine task performance is expected for higher compression levels that introduces larger distortion in the reconstructed feature maps.

### SUMMARY OF THE DISCLOSURE

In certain embodiments of the present disclosure, a video encoder in a system for video coding for machines is provided. The video encoder includes a neural network front end which receives image data and generates a plurality of feature layers. A layer context processor evaluates the context of objects in the image data which impacts the significance of the layers of the feature map for a machine task. A redundant layer identifier is coupled to the context processor and determines the relevance of the plurality of feature layers to a machine task at the decoder site. A layer filter receives the plurality of feature layers from the neural network front end and the output of the redundant layer identifier and performs at least one of removing a redundant layer and scaling a layer identified as having low relevance to a machine task to generate a filtered layer set. An encoder receives the filtered layer set and generates a coded bitstream of the filtered layer set.

In some embodiments, the video encoder provides signaling information in the coded bitstream indicating which layers of the plurality of layers are removed or modified by the layer filter. Preferably, plurality of feature layers from the neural network front end having decreasing size. In some embodiments, the neural network front end may be implemented with a feature pyramid network.

The present disclosure also includes embodiments of a decoder in a system for video coding for machines. The decoder receives an encoded bitstream generated by an encoder that generates a plurality of feature layers and selectively filters the plurality of plurality of feature layers prior to encoding. The bitstream preferably includes the filtered feature layers and signaling information identifying which layers were impacted by filtering at the encoder. The decoder decompresses the encoded bitstream, applies the signaling information to the decompressed bitstream and generates layers removed by filtering at the encoder. The decoded and reconstructed feature layers are applied to a neural network backend that is preferably trained for a machine task.

The disclosure further describes bitstreams and a method of transmitting an encoded bitstream for video coding for machines. Such methods include applying a neural network front end, receiving image data and generating a plurality of feature layers. The methods further include applying a layer context processor evaluating context of objects in the image data which impacts the significance of the layers of the feature map for a machine task and applying a redundant layer identifier applying the output of the context processor and determining the relevance of the plurality of feature layers to a machine task. A layer filter is applied and performs at least one of removing a redundant layer and scaling a layer identified as having low relevance to a machine task to generate a filtered layer set. An encoder is applied to generate the coded bitstream of the filtered layer set for transmission. Preferably, the coded bitstream includes signaling information indicating which layers of the plurality of layers are removed or modified by the layer filter and information for reversing the filtering process at the decoder, such as scaling information, where appropriate.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE FIGURES

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of a generalized R CNN known in the art;

FIG. 2 is a block diagram of a FCVCM system;

FIG. 3 is a block diagram further illustrating exemplary layers in the NN Part 1 of FIG. 2;

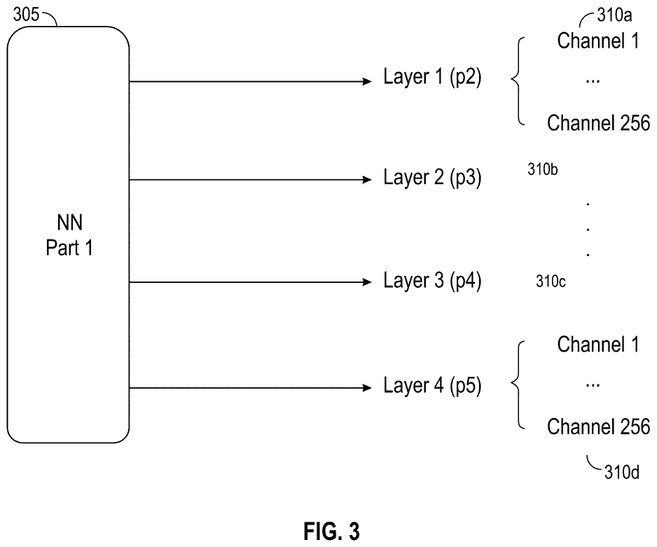

FIG. 4 is a pictorial representation of tiling of feature maps in accordance with the present disclosure;

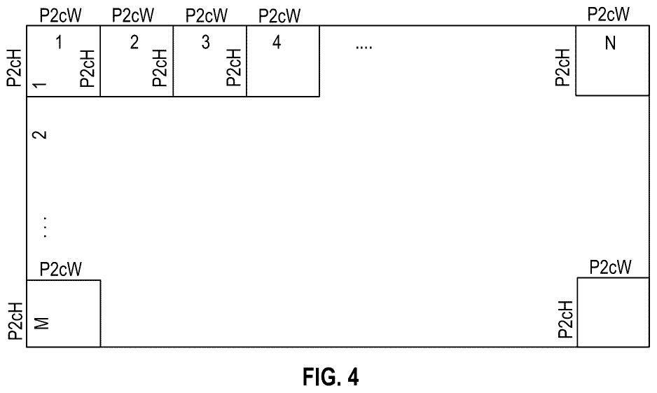

FIG. 5 is a pictorial representation of a tiled image in accordance with the present disclosure;

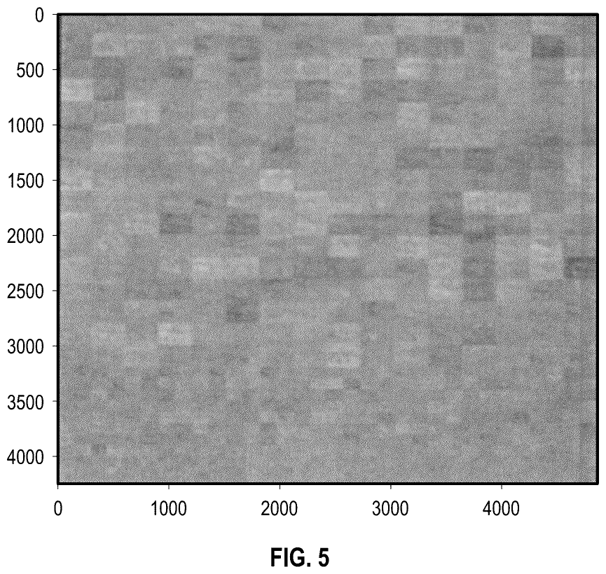

FIG. 6 is a simplified block diagram of an FCVCM system with layer filtering in accordance with the present disclosure;

FIG. 7 is a simplified block diagram of an FCVCM system with layer filtering in accordance with the present disclosure; and

FIG. 8 is a graph illustrating exemplary layer removal performance of the embodiment of FIG. 7;

FIG. 9 is a block diagram illustrating an exemplary embodiment of a video decoder;

FIG. 10 is a block diagram illustrating an exemplary embodiment of a video encoder; and

FIG. 11 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### EXEMPLARY EMBODIMENT OF THE PRESENT DISCLOSURE

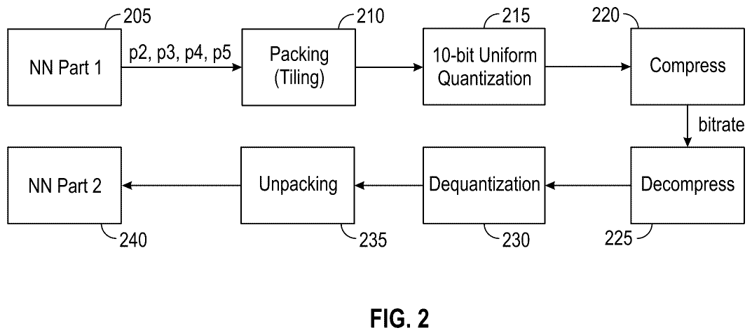

Referring to FIG. 2, the layers extracted from NN Part 1 205 of the neural network are packed 210, quantized 215, compressed 220 and transmitted to a receiver at a decoder site. At the receiver, the layer data is decoded, reconstructed into a format accepted by NN Part 2 240, and then input to NN Part 2 for completing the machine task.

Multi-scale feature networks use layers of different scales that retain different levels of information. Generally, there are larger layers that retain more information and smaller layers, depending on the network architectures, retain less information but allow the network to process larger more complex objects by focusing on its dominant features.

In some cases involving machine tasks, not all layers may be needed to process a given image, or video frame. Depending on the content of a frame, certain layers may be less important or fully redundant for a given task network. In such cases, redundant layers can be removed without affecting the machine task performance. For example, objects processed through multiple feature layers may be reduced to a size that is insignificant to a machine task. Since removing layers reduces the amount of layer data (feature maps), the storage and bandwidth requirements for the compressed feature maps may be reduced without adversely impacting machine task performance. Similarly, less important layers can be compressed at a higher level and with larger amount of compression loss, without substantial degradation in machine task performance.

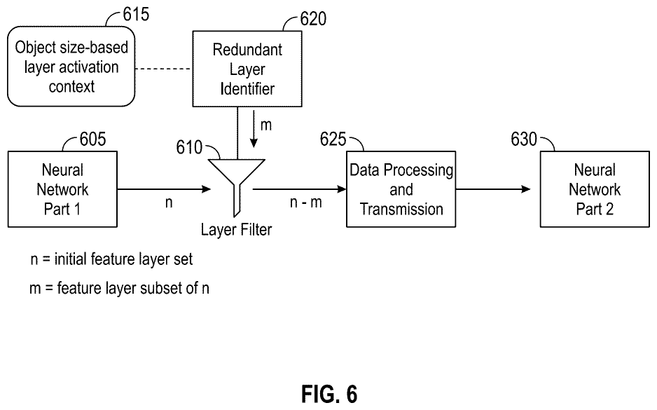

Referring to FIG. 6, by using contextual information from frame preprocessing as well as understanding of the applicable task network, layers can be downscaled, or fully removed from the system, thereby decreasing information passed to the encoder with little to no negative effect on system performance.

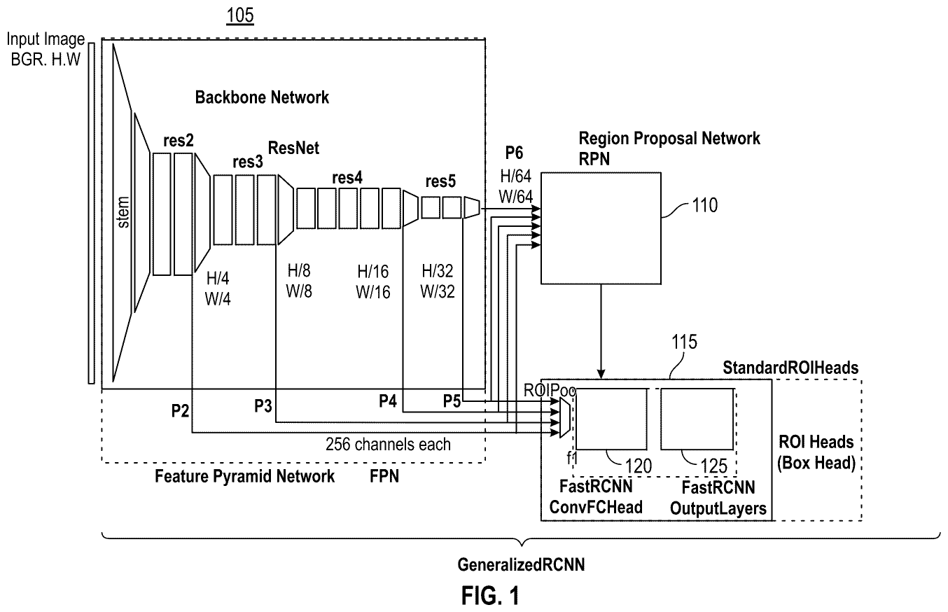

Neural Network Part 1 605: In this stage multi scale feature layers are extracted from the Neural Network, as described above in connection with FIGS. 1 and 2.

Object size-based layer activation context 615: In this processing block, context that impacts the significance of feature map in a given task network includes frame contents, encoding parameters, the type of objects, number of objects of a given type, object overlapping. Such context can be obtained using an object detection network such as YOLO.

Redundant Layer Identifier (RLI) 620: The RLI 620 algorithm utilizes the output of object size-based layer activation context 615 to identify which layers from NN Part 1 605 are most important for a given machine task. The RLI 620 can be implanted with a trained machine learning model that takes one of more of object size, count, and type as input outputs layer significance. Significance can be represented, for example, as a numeric value between 0 and 100, where 0 means fully redundant and 100 means fully essential. The RLI function can also be implemented as a set of rules based on the size of objects in the frame. Size of objects can be described using the pixel area covered by the bounding box of an object or a combination of the pixel area and the smaller of width and height. The presence of smaller objects in a frame, for example, would mark larger layers (e.g., P2 and P3) as essential and smaller layers as redundant (e.g., P4 and P5). Similarly, presence of objects larger than a threshold size S2 would lead to marking larger layers as redundant.

### EXAMPLE 1

```
if (object_size <= S1)
  Mark_layer_i_as_redundant;
else if (object_size > S1 AND object_size < S2)
  Mark_layer_i+1_as_redundant;
else if (object_size > S2 AND object_size < S3)
  Mark_layer_i+2_as_redundant;
else if (object_size >= S3)
  Mark_layer_i+3_as_redundant;
```

### EXAMPLE 2

```
if (object_size <= S1)
  Mark_layer_i_as_redundant;
else if (object_size > S1 AND object_size < S2)
  Mark_layer i+1 and i+2 as_redundant;
else if (object_size >= S2)
  Mark_layer_i+3_as_redundant;
```

Layer Filter 610: The Layer Filter 610 processes the layers in the original feature layer set n from NN Part 1 605 using the output of the RLI 620 to identify which of the n layers to remove or reduce. Methods employed by Layer Filter 610 can include fully removing layers, downscaling layers, or other processing of layers to reduce bitstream given select layer from RLI 620.

Remove layers: Layers that are determined to be fully redundant for the machine task can be completely removed at the sender (encoder input). The layer is removed at the encoder input by the layer filter 610 and the removed layer identifier is signaled to the receiver, such as by including the layer identifier parameters in a compressed bitstream. The receiver uses this signal in the compressed bitstream to replace the removed layers with default values (e.g., all 0s).

Scale layers: Layers that identified as less significant but not fully redundant can be scaled down (reduce layer size/resolution) at the sender side (encoder input) by the layer filter 610. A scaled down layer is encoded at the encoder input and the layer identifier and scale parameters such as the scale factor and scaler type used are signaled to the receiver, such as by including parameters in a compressed bitstream. The receiver uses these signaled parameters from the bitstream to rescale the decoded layers to the desired dimension.

Data Processing and Transmission 625: The output of layer filter 610 is applied to further processing steps for encoding, which can involve quantization, layer packing and compression of the processed layer data substantially as discussed in connection with FIG. 2. Processed information is then encoded, transmitted, decoded, postprocessed and sent to part two of the task network, substantially as illustrated in FIG. 2.

Neural Network Part 2 630: Similar to NN Part 2 in FIG. 2. NN Part 2 630 outputs the machine task output (e.g., object detection or segmentation information) for the given machine task.

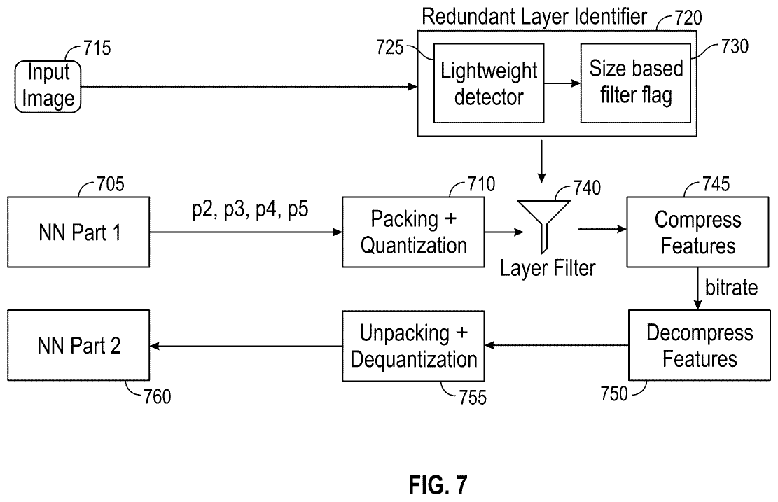

FIG. 7 is a simplified block diagram of a system implemented to perform the proposed layer filtering methods. As depicted in FIG. 7:

NN Part 1 705: In this stage features are extracted from a CNN implemented using the Res-Net 101 Neural Network. These features are composed of a plurality of layers each having a plurality of channels. In one embodiment, four layers each having 256 channels is used.

Redundant Layer Identifier Implementation: In this embodiment, RLL 720 employs an algorithm utilizing object size-based layer activation context 730 to identify which layers are most important for a given machine task. In this case context implies task network knowledge about activated layers for certain object sizes. The redundant layer identifier uses this context in conjunction with object detection 725, which may be implemented, for example, using a lightweight detector such as YOLOv3 object detection to flag layers as being redundant.

Layer Filter 740: As described above, layer filter 740 processes the data for the encoder. Filtering methods can include fully removing layers, downscaling, or other processing to reduce bitstream given select layer from redundant layer identifier 720. In this case data is fully removed from the image data, which may be a packed and quantized YUV file.

Compression 745: Once all processing has been completed the image is ready to be encoded, in this case encoding can be performed by known compression methods, such as with VTM-12.0 implementation of the VVC video compression.

Decompression: After the encoded image containing network features has been acquired by the receiving device, it is decompressed 750 and the features are decoded by a compatible decoder, such as the VTM-12.0 implementation of a VVC decoder.

Dequantization & Unpacking 755: The received image is dequantized and unpacked into the original network features that can be fed into the second half of the neural network. Dequantization and Unpacking 755 operate to reverse the process applied during encoding in the step packing and quantization operation 710.

NN Part 2 Processing 760: Once the raw layer information is acquired it can be directly fed into the second part of the neural network NN Part 2, from which object detection and/or segmentation information will be output for performing a relevant machine task.

Layers of feature maps excluded from the bitstream are preferably signaled in the bitstream so that the decoder can use that information to recreate the missing or modified layers at the receiver side. Excluded layers may be implicitly signaled, for example, by signaling the included layers. Any layer that is not included in the signaling is therefore not coded and will be created at the receiver.

Layer selection/inclusion may vary from frame to frame in video. As content in a video change, some included layer information in a feature coding for video coding for machines (fc-VCM) bitstream may also change. Such included layer information may remain unchanged for a group of successive frames in a video. In some applications, layer selection information may not change at all (e.g., a fixed camera monitoring a parking lot to count cars or people). A flexible bitstream syntax is preferable to signal different possibilities.

Frame layer information signaling can be included in the picture header to signal the layers in the picture, in the group of pictures (GOP) header when the layer information is the same for all the frames in a GOP, or in the sequence header or session header when layers remain unchanged for all frames in the video sequence. Other means of signaling layer information are possible.

Exemplary Bitstream Syntax for signaling layer information:

| | Descriptor |
|---|---|
| frame_layer_information( ) { | |
| fli_num_ layers | u(3) |
| for(i=0; i <= fli_num_layers; i++){ | |
| fli_layer_id | u(3) |
| fli_layer_included | u(1) |
| }else(!fli_layer_included){ | |
| fli_layer_fill_method | u(8) |
| if(fli_layer_fill_method == 3){ | u(10) |
| const_fill_value | |
| } | |
| } | |
| } | |

fli_num_layers: number of layers per frame
fli_layer_id: id of the layer. With a 3-bit value, up to 8 layers can be signaled.
fli_layer_included: a flag indicating whether feature map data for a particular layer is included in the bitstream.
fli_layer_fill_method: method to fill the missing layer at the receiver. A value of 0 indicates that all feature maps not included in the bitstream must be set to 0 (zero fill layer). When fli_layer_fill_method is set to 1, the average value of the next larger layer is used to fill. When fli_layer_fill_method is set to 2, the average value of the next smaller layer is used to fill.
const_fill_value: if fli_layer_fill_method value is 3, a constant value to fill in the missing layer data is included. This value is represented in the same units are the coded feature map data. If the coded layer data is 10-bit quantized values, constant fill is also coded as the 10-bit quantized value.

The bitstream syntax shown is exemplary and the capabilities described above may be signaled using a different bitstream syntax.

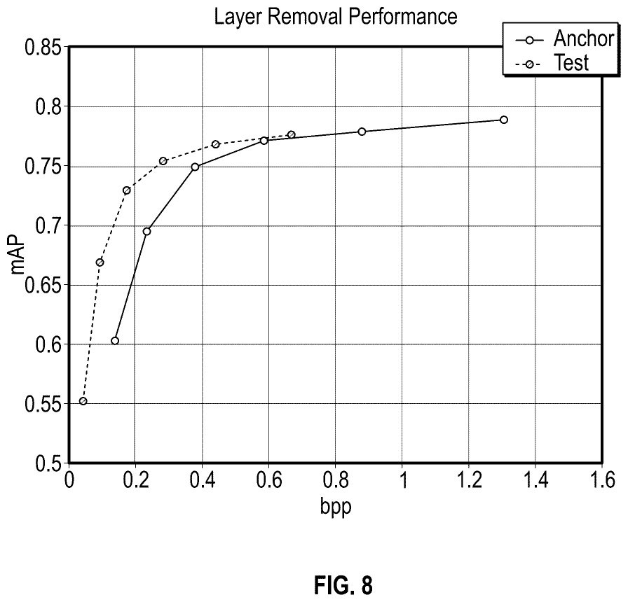

An illustration of exemplary results for the system of FIG. 7 are illustrated in the graph depicted in FIG. 8.

The system in FIG. 7 is one exemplary implementation using layer removal and layer reduction. The system preferably uses a lightweight detector 725, such as YOLOv3, to gauge the relative size of objects. This information is passed through an algorithm that uses network context of layer importance for object sizes to make decisions about which layers to mark as redundant. Preferably, the redundant layers are removed from the bitstream. System performance in this regard was evaluated using openImages5k dataset, as illustrated in FIG. 8.

The disclosed methods can produce a bitstream that is compliant with known video standards, such as the VVC standard and decodable with a VVC compliant decoder. The disclosed method can also be used to reduce the complexity of other video encoding standards, such as HEVC and AV1.

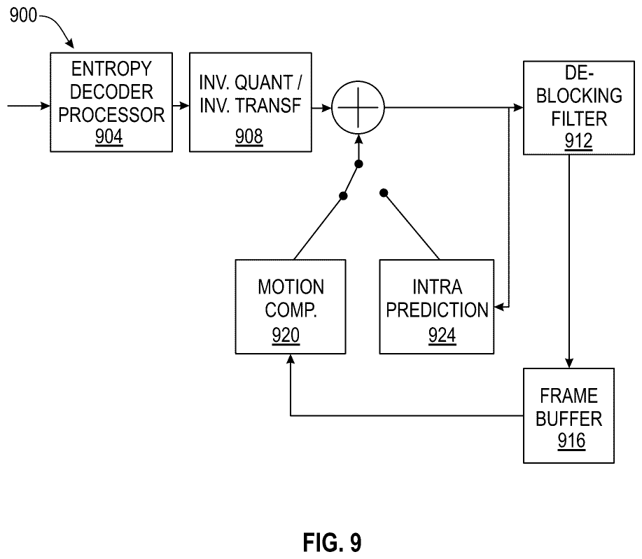

FIG. 9 is a system block diagram illustrating an example of a decoder 900 capable of practicing the present methods. Decoder 900 may include an entropy decoder processor 904, an inverse quantization and inverse transformation processor 908, a deblocking filter 912, a frame buffer 916, a motion compensation processor 920 and/or an intra prediction processor 924.

In operation, and still referring to FIG. 9, bit stream 928 may be received by decoder 900 and input to entropy decoder processor 904, which may entropy decode portions of bit stream into quantized coefficients. Quantized coefficients may be provided to inverse quantization and inverse transformation processor 908, which may perform inverse quantization and inverse transformation to create a residual signal, which may be added to an output of motion compensation processor 920 or intra prediction processor 924 according to a processing mode. An output of the motion compensation processor 920 and intra prediction processor 924 may include a block prediction based on a previously decoded block. A sum of prediction and residual may be processed by deblocking filter 912 and stored in a frame buffer 916.

In an embodiment, and still referring to FIG. 9 decoder 900 may include circuitry configured to implement any operations as described above in any embodiment as described above, in any order and with any degree of repetition. For instance, decoder 900 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Decoder may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

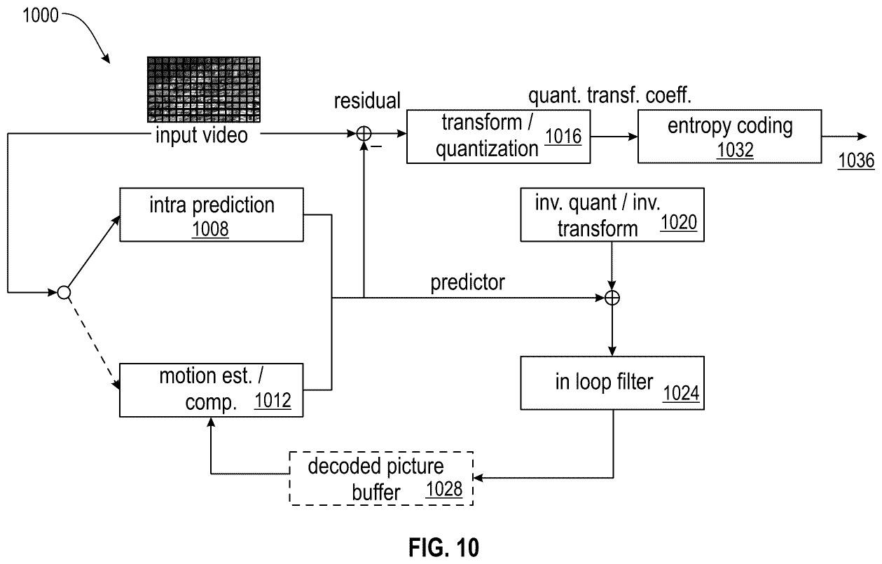

FIG. 10 is a system block diagram illustrating an example video encoder 1000 capable of adaptive cropping. Example video encoder 1000 may receive an input video 1004, which may be initially segmented or dividing according to a processing scheme, such as a tree-structured macro block partitioning scheme (e.g., quad-tree plus binary tree). An example of a tree-structured macro block partitioning scheme may include partitioning a picture frame into large block elements called coding tree units (CTU). In some implementations, each CTU may be further partitioned one or more times into a number of sub-blocks called coding units (CU). A final result of this portioning may include a group of sub-blocks that may be called predictive units (PU). Transform units (TU) may also be utilized.

Still referring to FIG. 10, example video encoder 1000 may include an intra prediction processor 1008, a motion estimation/compensation processor 1012, which may also be referred to as an inter prediction processor, capable of constructing a motion vector candidate list including adding a global motion vector candidate to the motion vector candidate list, a transform/quantization processor 1016, an inverse quantization/inverse transform processor 1020, an in-loop filter 1024, a decoded picture buffer 1028, and/or an entropy coding processor 1032. Bit stream parameters may be input to the entropy coding processor 1032 for inclusion in the output bit stream 1036.

In operation, and with continued reference to FIG. 10, for each block of a frame of input video, whether to process block via intra picture prediction or using motion estimation/compensation may be determined. Block may be provided to intra prediction processor 1008 or motion estimation/compensation processor 1012. If block is to be processed via intra prediction, intra prediction processor 1008 may perform processing to output a predictor. If block is to be processed via motion estimation/compensation, motion estimation/compensation processor 1012 may perform processing including constructing a motion vector candidate list including adding a global motion vector candidate to the motion vector candidate list, if applicable.

Further referring to FIG. 10, a residual may be formed by subtracting a predictor from input video. Residual may be received by transform/quantization processor 1016, which may perform transformation processing (e.g., discrete cosine transform (DCT)) to produce coefficients, which may be quantized. Quantized coefficients and any associated signaling information may be provided to entropy coding processor 1032 for entropy encoding and inclusion in output bit stream 1036. Entropy encoding processor 1032 may support encoding of signaling information related to encoding a current block. In addition, quantized coefficients may be provided to inverse quantization/inverse transformation processor 1020, which may reproduce pixels, which may be combined with a predictor and processed by in loop filter 1024, an output of which may be stored in decoded picture buffer 1028 for use by motion estimation/compensation processor 1012 that is capable of constructing a motion vector candidate list including adding a global motion vector candidate to the motion vector candidate list.

With continued reference to FIG. 10, although a few variations have been described in detail above, other modifications or additions are possible. For example, in some implementations, current blocks may include any symmetric blocks (8×8, 16×16, 32×32, 64×64, 128×128, and the like) as well as any asymmetric block (8×4, 16×8, and the like).

In some implementations, and still referring to FIG. 10, a quadtree plus binary decision tree (QTBT) may be implemented. In QTBT, at a Coding Tree Unit level, partition parameters of QTBT may be dynamically derived to adapt to local characteristics without transmitting any overhead. Subsequently, at a Coding Unit level, a joint-classifier decision tree structure may eliminate unnecessary iterations and control the risk of false prediction. In some implementations, LTR frame block update mode may be available as an additional option available at every leaf node of QTBT.

In some implementations, and still referring to FIG. 10, additional syntax elements may be signaled at different hierarchy levels of bitstream. For example, a flag may be enabled for an entire sequence by including an enable flag coded in a Sequence Parameter Set (SPS). Further, a CTU flag may be coded at a coding tree unit (CTU) level.

Some embodiments may include non-transitory computer program products (i.e., physically embodied computer program products) that store instructions, which when executed by one or more data processors of one or more computing systems, cause at least one data processor to perform operations herein.

Still referring to FIG. 10, encoder 1000 may include circuitry configured to implement any operations as described above in any embodiment, in any order and with any degree of repetition. For instance, encoder 1000 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Encoder 1000 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 10, non-transitory computer program products (i.e., physically embodied computer program products) may store instructions, which when executed by one or more data processors of one or more computing systems, causes at least one data processor to perform operations, and/or steps thereof described in this disclosure, including without limitation any operations described above and/or any operations decoder 900 and/or encoder 1000 may be configured to perform. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, or the like.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

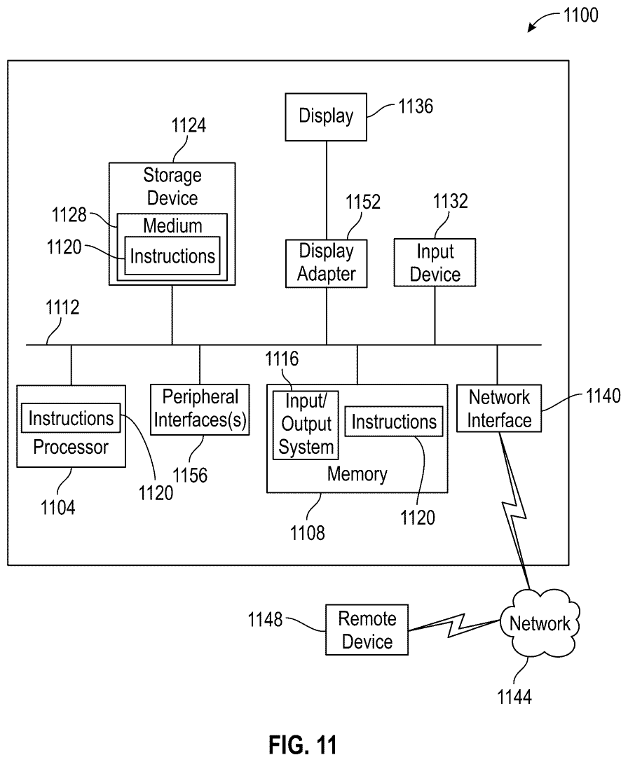

FIG. 11 shows a diagrammatic representation of one embodiment of a computing device in the exemplary form of a computer system 1100 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1100 includes a processor 1104 and a memory 1108 that communicate with each other, and with other components, via a bus 1112. Bus 1112 may include any of several types of bus structures including, but not limited to, a memory bus, a memory controller, a peripheral bus, a local bus, and any combinations thereof, using any of a variety of bus architectures.

Processor 1104 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1104 may be organized according to Von Neumann and/or Harvard architecture as a non-limiting example. Processor 1104 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), and/or system on a chip (SoC)

Memory 1108 may include various components (e.g., machine-readable media) including, but not limited to, a random-access memory component, a read only component, and any combinations thereof. In one example, a basic input/output system 1116 (BIOS), including basic routines that help to transfer information between elements within computer system 1100, such as during start-up, may be stored in memory 1108. Memory 1108 may also include (e.g., stored on one or more machine-readable media) instructions (e.g., software) 1120 embodying any one or more of the aspects and/or methodologies of the present disclosure. In another example, memory 1108 may further include any number of program modules including, but not limited to, an operating system, one or more application programs, other program modules, program data, and any combinations thereof.

Computer system 1100 may also include a storage device 1124. Examples of a storage device (e.g., storage device 1124) include, but are not limited to, a hard disk drive, a magnetic disk drive, an optical disc drive in combination with an optical medium, a solid-state memory device, and any combinations thereof. Storage device 1124 may be connected to bus 1112 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1124 (or one or more components thereof) may be removably interfaced with computer system 1100 (e.g., via an external port connector (not shown)). Particularly, storage device 1124 and an associated machine-readable medium 1128 may provide nonvolatile and/or volatile storage of machine-readable instructions, data structures, program modules, and/or other data for computer system 1100. In one example, software 1120 may reside, completely or partially, within machine-readable medium 1128. In another example, software 1120 may reside, completely or partially, within processor 1104.

Computer system 1100 may also include an input device 1132. In one example, a user of computer system 1100 may enter commands and/or other information into computer system 1100 via input device 1132. Examples of an input device 1132 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1132 may be interfaced to bus 1112 via any of a variety of interfaces (not shown) including, but not limited to, a serial interface, a parallel interface, a game port, a USB interface, a FIREWIRE interface, a direct interface to bus 1112, and any combinations thereof. Input device 1132 may include a touch screen interface that may be a part of or separate from display 1136, discussed further below. Input device 1132 may be utilized as a user selection device for selecting one or more graphical representations in a graphical interface as described above.

A user may also input commands and/or other information to computer system 1100 via storage device 1124 (e.g., a removable disk drive, a flash drive, etc.) and/or network interface device 1140. A network interface device, such as network interface device 1140, may be utilized for connecting computer system 1100 to one or more of a variety of networks, such as network 1144, and one or more remote devices 1148 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1144, may employ a wired and/or a wireless mode of communication. In general, any network topology may be used. Information (e.g., data, software 1120, etc.) may be communicated to and/or from computer system 1100 via network interface device 1140.

Computer system 1100 may further include a video display adapter 1152 for communicating a displayable image to a display device, such as display device 1136. Examples of a display device include, but are not limited to, a liquid crystal display (LCD), a cathode ray tube (CRT), a plasma display, a light emitting diode (LED) display, and any combinations thereof. Display adapter 1152 and display device 1136 may be utilized in combination with processor 1104 to provide graphical representations of aspects of the present disclosure. In addition to a display device, computer system 1100 may include one or more other peripheral output devices including, but not limited to, an audio speaker, a printer, and any combinations thereof. Such peripheral output devices may be connected to bus 1112 via a peripheral interface 1156. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

What is claimed:

1. A video encoder in a system for video coding for machines, comprising:
a neural network front end, the neural network front end receiving image data and generating a plurality of feature layers;
layer context processor evaluating context of objects in the image data which impacts the significance of the layers of the feature map for a machine task;
a redundant layer identifier, the redundant layer identifier applying the output of the context processor and determining the relevance of the plurality of feature layers to a machine task;
a layer filter, the layer filter receiving the plurality of feature layers from the neural network front end and the output of the redundant layer identifier and performing at least one of removing a redundant layer and scaling a layer identified as having low relevance to a machine task to generate a filtered layer set;
an encoder receiving the filtered layer set and generating a coded bitstream of the filtered layer set.

2. The video encoder of claim 1 further comprising signaling information in the coded bitstream indicating which layers of the plurality of layers are removed or modified by the layer filter.

3. The video encoder of claim 1, wherein the plurality of layers have decreasing layer size.

4. The video encoder of claim 1, wherein the neural network front end comprises a feature pyramid network.

5. The video encoder of claim 1, wherein the redundant layer identifier further comprises a lightweight object detector.

6. A decoder in a system for video coding for machines, comprising circuitry configured to:
receive an encoded bitstream generated by an encoder that generates a plurality of feature layers and selectively filters the plurality of plurality of feature layers prior to encoding, the bitstream comprising the filtered feature layers and signaling information identifying which layers were impacted by filtering;
decompress the encoded bitstream;
applying the signaling information to the decompressed bitstream and generating layers removed by filtering at the encoder;
applying the reconstructed feature layers to a neural network trained for a machine task.

7. The decoder of claim 6, wherein the signaling information explicitly signals which layers are removed during encoding.

8. The decoder of claim 6, wherein the signaling information implicitly signals which layers are removed during encoding.

9. A method of transmitting an encoded bitstream for video coding for machines, comprising:
applying a neural network front end, the neural network front end receiving image data and generating a plurality of feature layers;
applying a layer context processor evaluating context of objects in the image data which impacts the significance of the layers of the feature map for a machine task;
applying a redundant layer identifier, the redundant layer identifier applying the output of the context processor and determining the relevance of the plurality of feature layers to a machine task;
applying a layer filter, the layer filter receiving the plurality of feature layers from the neural network front end and the output of the redundant layer identifier and performing at least one of removing a redundant layer and scaling a layer identified as having low relevance to a machine task to generate a filtered layer set;
applying an encoder receiving the filtered layer set and generating the coded bitstream of the filtered layer set for transmission.

10. The method of claim 9, wherein the coded bitstream further comprises signaling information in the coded bitstream indicating which layers of the plurality of layers are removed or modified by the layer filter.

11. The method of claim 10, wherein the bitstream explicitly signals which layers are removed by the layer filter.

12. The method of claim 10, wherein the bitstream implicitly signals which layers are removed by the layer filter.
